(19) United States
(12) Patent Application Publication
(10) Pub. No.: US 2014/0326747 A1
(43) Pub. Date: Nov. 6, 2014

(54) ROTATABLE GRAIN STORAGE ASSEMBLY

(71) Applicant: Sukup Manufacturing Co., Sheffield, IA (US)

(72) Inventor: Eugene G. Sukup, Hampton, IA (US)

(21) Appl. No.: 14/338,609

(22) Filed: Jul. 23, 2014

Related U.S. Application Data
(62) Division of application No. 13/678,184, filed on Nov. 15, 2012.
(60) Provisional application No. 61/560,912, filed on Nov. 17, 2011.

(51) Int. Cl. B65G 65/23; B65B 1/06

(52) U.S. Cl. CPC B65G 65/23; B65B 1/06
USPC 222/1; 53/467

(57) ABSTRACT

A barrel for holding grain is positioned on a plurality of rollers that are rotatably connected to longitudinally extending support members. The support members are connected to a frame that is selectively adjustable.

### CROSS REFERENCE TO RELATED APPLICATION

This application claims the benefit of U.S. Provisional Application No. 61/560,912 filed Nov. 17, 2011.

### BACKGROUND OF THE INVENTION

This invention is directed toward a grain storage assembly and more specifically to a storage assembly for small farmers to maintain a supply of grain for food.

Small farmers in foreign countries store grain as food to last throughout the year. With present storage systems, approximately 20-25% of the grain is lost to spoilage. One of the primary causes of the spoilage is from weevils and other rodents who nest within the storage containers and eat the grain. One way to cure this problem is to seal the storage containers as weevils cannot survive without oxygen. Therefore, there is a need in the art for a device that addresses these needs.

An objective of the present invention is to provide a storage assembly that reduces spoilage.

Another objective of the present invention is to provide a storage assembly that has an air tight seal.

A still further objective of the present invention is to provide a storage assembly that is easy to load and unload.

These and other objectives will be apparent to one of ordinary skill in the art based upon the following disclosure.

### SUMMARY OF THE INVENTION

A rotatable grain storage assembly having adjustable support members slidably connected to front and rear legs. Primary support members, having rollers rotatably attached thereto, are connected to and are positioned transverse to the adjustable support member. A barrel having at least one opening and an air tight lid is positioned on the rollers.

### BRIEF DESCRIPTION OF THE FIGURES

FIG. 1 is a side view of a rotatable grain storage assembly;

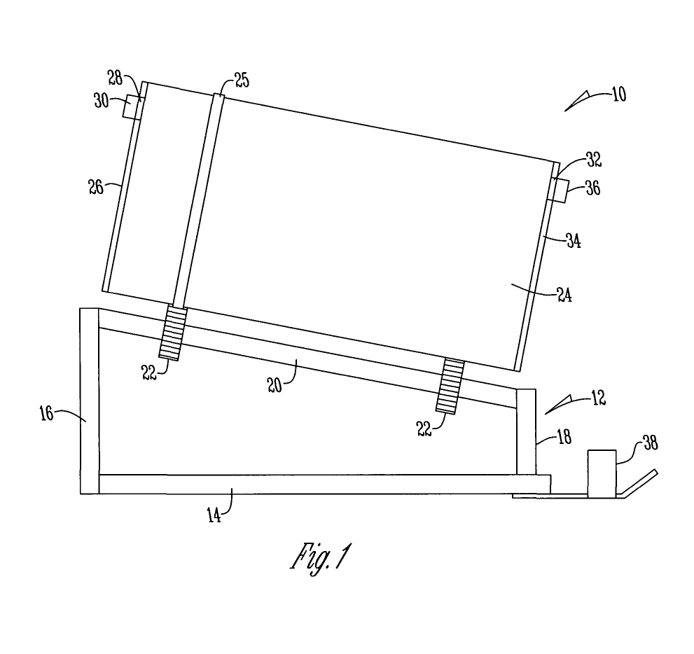

FIG. 2 is a perspective view of a rotatable grain storage assembly; and

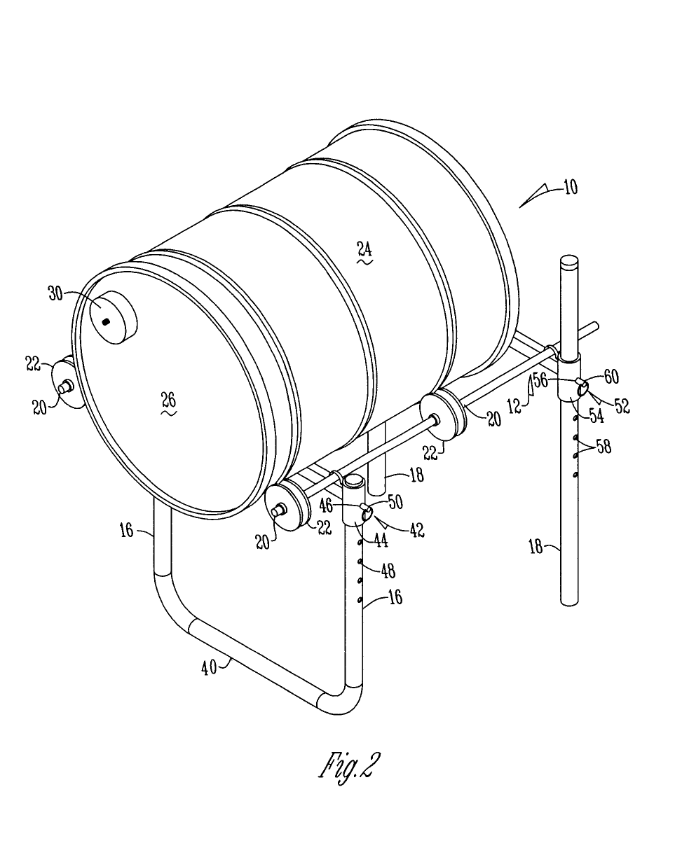

FIG. 3 is a perspective view of a rotatable grain storage assembly during transport.

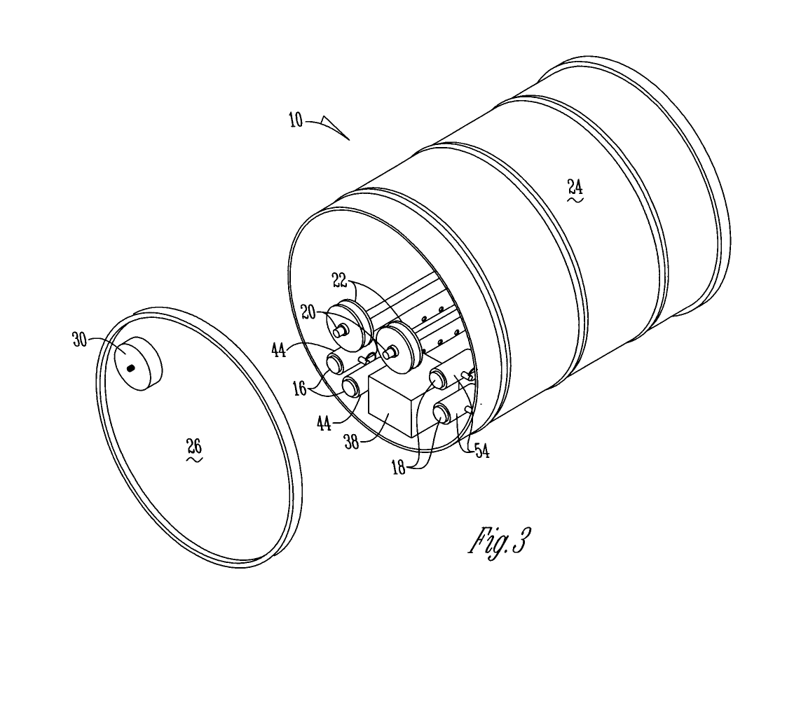

### DETAILED DESCRIPTION OF THE PREFERRED EMBODIMENT

Referring to the Figure, the grain storage assembly 10 has a frame 12 preferably made of hollow pipe. The frame 12 includes a base 14, front and rear legs 16, 18 connected to the base 14 and a pair of support members 20 connected to the legs 16, 18. The rear legs 18 are shorter than the front legs 16 such that the support members 20 angle downwardly from the front toward the rear. Rotatably mounted to each support member is at least one, and preferably two rollers 22.

Placed upon the support members 20 is a barrel 24. The barrel 24 is of any size or shape and preferably is a 55 gallon paint barrel. Preferably the barrel 24 has a handle 25 such as a ring that goes around the barrel 24. For larger barrels 24 a crank is attached to the roller. On at least one end of the barrel 24 is an air tight lid 26. The lid 26 has an opening 28 that receives a cap 30. The opening preferably has a diameter of 6 inches. The cap 30 is removably connected to the opening 28 preferably by threads or the like to create an air tight seal. In one embodiment, the opposite end of the barrel 24 has an opening 32 in an air tight lid 34 that receives a cap 36. In an alternative embodiment, a jack 38 is positioned to raise and lower the rear end of the frame 12.

To transport or ship the storage assembly 10, the frame 12 is disassembled and along with the jack 38 placed inside the barrel 24 which is then resealed. To operate, the frame 12 is assembled and the barrel 24 placed upon the rollers 22. The barrel 24 is then filled with grain and lid 26 is placed on the front end to create an air tight seal. The angle of the barrel 24 allows for easy loading of the grain.

When one wishes to remove grain, cap 30 is removed to allow an individual to reach through opening 28 and remove the grain. Once the grain is removed, the opening 28 is resealed with cap 30. As the level of grain goes down within the barrel 24, the barrel 24 is rotated so that opening 28 moves closer to a 6 o′clock position and closer to the reduced grain level within the barrel 24. When the barrel is close to empty, the jack 38 is used to raise the rear legs 18 so that the barrel 24 is angled downwardly from the rear end toward the front end which allows grain to flow toward the front end.

Alternatively, grain is removed through opening 32 in a similar fashion by rotating the barrel 24 on the rollers 22 as needed when the grain level is reduced. Accordingly, a grain storage assembly has been described that at the very least meets all the stated objectives.

In an alternative embodiment, the front legs 16 are formed by a continuous U-shaped hollow pipe such that a base portion 40 extends between the legs 16 and contacts the ground. Also included in the frame is a first adjustable support member 42 having hollow cylinders 44 on each end that slidably fit over legs 16. The cylinders 44 have an opening 46 that aligns with openings 48 in legs 16 to receive a pin 50 for selectively adjusting the height of the support member 42 in relation to the legs 16.

A second adjustable support member 52 has hollow cylinders 54 on each end that slidably fit over rear legs 18. Cylinders 54 also have an opening 56 that aligns with openings 58 in legs 18 to receive a pin 60 for selective adjustment.

1-6. (canceled)

7. A method of using rotatable grain storage assembly for the storage and controlled removal of grain, the steps comprising:
providing a grain storage assembly comprising:
a frame having front legs and rear legs;
wherein the rear legs are shorter than the front legs;
a pair of support members, having rollers rotatably attached, are connected to the frame; and
a barrel having at least one opening in a lid, the opening covered by a removable cap; filling the barrel with grain and storing grain within the barrel;
positioning the barrel on top of the frame at a downward angle such that the lid is positioned on a downward facing end of the barrel;
removing grain from the barrel by removing the cap from the lid; and
rotating the barrel on the rollers as a level of the grain within the barrel is reduced such that that the opening moves to a lower position thereby facilitating controlled removal of the grain at various grain levels.

8. The method of claim 7 wherein the frame is vertically selectively adjustable.

9. The method of claim 7 wherein the barrel further includes an upward facing end having an opening and a removable cap.

10. The method of claim 7 wherein an adjustable support member is slidably connected to the front legs.

11. The method of claim 7 wherein an adjustable support member is connected to the rear legs.

12. The method of claim 7 wherein a handle in the form of a ring is positioned around the barrel.

13. The method of claim 7 further comprising a jack connected to the frame and positioned to raise and lower a rear end of the frame.

14. A method of using a rotatable grain storage assembly for the storage and controlled removal of grain, the steps comprising:
providing a grain storage assembly comprising:
a frame having front legs and rear legs;
wherein the rear legs are shorter than the front legs;
a support member having hollow cylinders at each end that slidably fit over the front legs and are adjustably connected to the front legs;
a pair of support arms connected to the frame, the support arms having rollers rotatably attached thereto; and
a barrel having a lid connected to a first end of the barrel, the lid having an opening covered by a cap;
filling the barrel with grain and storing grain within the barrel;
positioning the barrel on top of the frame such that the first end of the barrel is positioned at a downward angle;
removing grain from the barrel by removing the cap from the lid; and
rotating the barrel on the rollers as a level of the grain within the barrel is reduced, such that that the opening moves to a lower position thereby facilitating controlled removal of the grain at various grain levels.

15. The method of claim 14 wherein the front legs are formed by a U-shaped member having a base portion that extends between the front legs and contacts a ground surface.

16. The method of claim 14 wherein the frame further comprising a second support member with hollow cylinders at a second end that slidably fit over the rear legs and are adjustably connected to the rear legs.

17. The method of claim 14 wherein the barrel has a handle.

18. The method of claim 14 further comprising a jack positioned to raise and lower a rear end of the frame.

19. The method of claim 12 further comprising the step of using the jack to raise the rear legs to increase the downward angle of the barrel.

20. A method of using a rotatable grain storage assembly for the storage and controlled removal of grain, the steps comprising:
providing a grain storage assembly, comprising:
a frame having front legs and rear legs;
wherein the rear legs are shorter than the front legs;
a pair of support members having rollers rotatably connected to the frame; and
a barrel having a handle and a lid connected to a first end of the barrel, the lid having an opening covered by a cap;
shipping the grain storage with the frame and the support members positioned within the barrel to facilitate easier transporting;
assembling the grain storage assembly;
filling the barrel with grain and storing grain within the barrel;
positioning the barrel at a downward angle on the rollers such that the lid is positioned on a downward facing end of the barrel.

21. The method of claim 20 further comprising the step of rotating the barrel on the rollers such that the opening moves to a lower position as the level of grain within the barrel is reduced thereby facilitating controlled removal of the grain at various grain levels.

22. The method of claim 20 wherein the barrel further includes a second end, opposite the first end, the second end having an opening selectively covered by a cap.

23. The method of claim 20 wherein an adjustable support member is slidably connected to the front legs.

24. The method of claim 20 wherein an adjustable support member is connected to the rear legs.
